(19) United States
(12) Patent Application Publication
(10) Pub. No.: US 2013/0000602 A1
(43) Pub. Date: Jan. 3, 2013

(54) METHODS AND SYSTEMS FOR CONTROLLING FUEL SYSTEMS OF INTERNAL COMBUSTION ENGINES

(75) Inventors: Dana Ray COLDREN, Secor, IL (US); Stephen Robert LEWIS, Chillicothe, IL (US); Lifeng WANG, Dunlap, IL (US)

(73) Assignee: Caterpillar Inc.

(21) Appl. No.: 13/173,871

(22) Filed: Jun. 30, 2011

(51) Int. Cl. F02D 41/30; F02D 41/00

(52) U.S. Cl. 123/445

(57) ABSTRACT

A method of operating a power system is disclosed. The power system may include an engine. The engine may include a combustion chamber, a drive member, and a fuel system with a fuel injector. The method may include selectively operating the fuel system to supply fuel from the fuel injector to the combustion chamber and combusting the fuel in the combustion chamber to drive the drive member. The method may also include selectively operating the fuel system to generate parasitic losses without supplying fuel to the combustion chamber to drive the drive member. Operating the fuel system to generate parasitic losses may include generating pressure in a component of the fuel system with power derived from the engine and dissipating at least a portion of the generated pressure without delivering fuel from the fuel injector to the combustion chamber.

### TECHNICAL FIELD

The present disclosure relates to internal combustion engines and, more particularly, to methods and systems for controlling fuel systems of internal combustion engines.

### BACKGROUND

Many machines include an internal combustion engine for producing power. Internal combustion engines typically include a fuel system for delivering fuel to one or more combustion chambers of the engine, where the fuel combusts to provide power. The fuel systems of internal combustion engines typically use engine power to move fuel, which can detract from the net power available to the engine.

U.S. Pat. No. 7,523,606 to Strauser et al. (“the '606 patent”) discloses a parasitic load control system that uses the parasitic losses of a fuel system to its advantage. The '606 patent discloses increasing the parasitic losses generated by an engine's fuel system while the engine is producing power. The '606 patent discloses that increasing fuel-system parasitic losses while the engine is running may increase the temperature of the engine's exhaust gas, which may allow exhaust aftertreatment devices to operate more effectively.

Although the '606 patent discusses benefits of increasing fuel-system parasitic losses while operating an engine to produce power, the methods and systems of the present disclosure may address additional beneficial uses of fuel-system parasitic losses.

### SUMMARY

One disclosed embodiment relates to a method of operating a power system. The power system may include an engine. The engine may include a combustion chamber, a drive member, and a fuel system with a fuel injector. The method may include selectively operating the fuel system to supply fuel from the fuel injector to the combustion chamber and combusting the fuel in the combustion chamber to drive the drive member. The method may also include selectively operating the fuel system to generate parasitic losses without supplying fuel to the combustion chamber to drive the drive member. Operating the fuel system to generate parasitic losses may include generating pressure in a component of the fuel system with power derived from the engine and dissipating at least a portion of the generated pressure without delivering fuel from the fuel injector to the combustion chamber.

Another embodiment relates to a power system. The power system may include an engine. The engine may include a combustion chamber, a drive member, a fuel system with a fuel injector, and a controller. The controller may be configured to selectively operate the fuel system to supply fuel from the fuel injector to the combustion chamber to combust the fuel in the combustion chamber and drive the drive member. The controller may further be configured to selectively operate the fuel system to generate parasitic losses without supplying fuel to the combustion chamber to drive the drive member. The controller selectively operating the fuel system to generate parasitic losses may include generating pressure in a component of the fuel system with power derived from the engine and dissipating at least a portion of the generated pressure without delivering fuel from the fuel injector to the combustion chamber.

A further disclosed embodiment relates to a method of operating a power system. The power system may include an engine with a fuel system. The method may include receiving a braking signal. The method may further include, in response to the braking signal, altering operation of the fuel system to increase parasitic losses of the fuel system.

### BRIEF DESCRIPTION OF THE DRAWINGS

FIG. 1 illustrates one embodiment of a machine with a power system according to the present disclosure;

FIG. 2 provides a detailed view of one embodiment of an engine and fuel system according to the present disclosure;

FIG. 3 provides a detailed view of one embodiment of a fuel injector according to the present disclosure;

FIG. 4A provides an illustration of one operating state of the fuel injector shown in FIG. 3;

FIG. 4B provides an illustration of another operating state of the fuel injector shown in FIG. 3;

FIG. 4C provides an illustration of another operating state of the fuel injector shown in FIG. 3;

FIG. 4D provides an illustration of another operating state of the fuel injector shown in FIG. 3;

FIG. 4E provides an illustration of another operating state of the fuel injector shown in FIG. 3;

FIG. 5 provides a detailed view of another embodiment of an engine and fuel system according to the present disclosure;

FIG. 6 graphically illustrates one method of controlling certain parameters of a fuel system according to the present disclosure; and

FIG. 7 graphically illustrates another method of controlling certain parameters of a fuel system according to the present disclosure.

### DETAILED DESCRIPTION

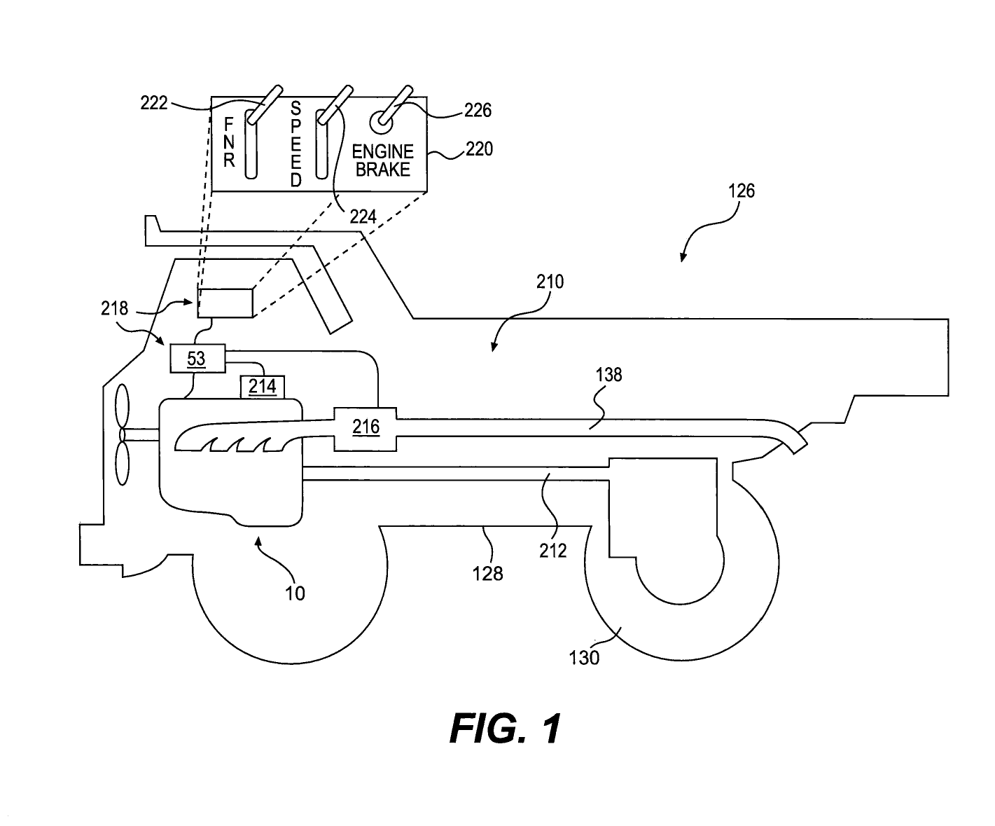

FIG. 1 illustrates a machine 126 having a frame 128 and a power system 210 according to the present disclosure. Power system 210 may include an engine 10 for producing power to perform various tasks. Engine 10 may be any type of engine that produces power by combusting fuel, including, but not limited to, a diesel engine, a gasoline engine, and a gaseous fuel-powered engine. Power system 210 may also include an exhaust system 138 for exhausting combustion gases produced by engine 10.

Power system 210 may also include various components that receive power from engine 10 and use that power to perform various tasks. For example, in the embodiment shown in FIG. 1, power system 210 may include a drivetrain 212 and propulsion devices 130 drivingly connected to engine 10 to propel machine 126 with power from engine 10. Propulsion devices 130 may be wheels, track units, or any other type of device operable to receive power from engine 10 via drivetrain 212 and apply the received power to propel machine 126. Drivetrain 212 may include any component or components operable to transmit power from engine 10 to propulsion devices 130, including, but not limited to, clutches, fluid couplers, electric generators and motors, hydraulic pumps and motors, gears, driveshafts, chains, belts, pulleys, and the like.

In some embodiments, power system 210 may also include one or more dedicated engine-braking devices operable to create parasitic loads on engine 10. For example, power system 210 may include a compression-braking device 214 operably associated with engine 10. Compression-braking device 214 may include one or more components of engine 10 itself and/or components that are separate from engine 10. Compression-braking device 214 may be configured to generate parasitic losses of engine 10 by, for example, opening exhaust valves (not shown) of engine 10 to release compressed gas from engine 10 without recovering the energy from the compressed gas. A variety of devices that operate in such a manner are known.

Another type of engine-braking device some embodiments of the disclosed power system 210 may have is an exhaust-braking device 216. Exhaust-braking device 216 may include components of engine 10 itself and/or components that are separate from engine 10. Exhaust-braking device 216 may, for example, be connected in exhaust system 138. Exhaust-braking device 216 may be configured to selectively restrict the flow of exhaust gases in exhaust system 138, creating a parasitic loss of engine 10 by increasing the amount of work engine 10 must do to force exhaust gas through exhaust system 138.

Power system 210 may further include power-system controls 218 configured to monitor and/or control one or more aspects of the operation of power system 210. Power-system controls 218 may include a controller 53. Controller 53 may embody a single microprocessor or multiple microprocessors that include a means for controlling power system 210. Numerous commercially available microprocessors can be configured to perform the functions of controller 53. It should be appreciated that controller 53 could readily embody a general machine or engine microprocessor capable of controlling numerous machine or engine functions. Controller 53 may include all the components required to run an application such as, for example, a memory, a secondary storage device, and a processor, such as a central processing unit or any other means known in the art for controlling various components of power system 210. Various other known circuits may be associated with controller 53, including power supply circuitry, signal-conditioning circuitry, solenoid driver circuitry, communication circuitry, and other appropriate circuitry.

Controller 53 may monitor and/or control various aspects of the operation of power system 210. For example, in response to inputs from an operator, controller 53 may be configured (i.e., programmed) to control whether and how power system 210 propels machine 126 by monitoring and controlling the operating speed and power output of engine 10, as well as the operating state of various components of drivetrain 212. To enable controller 53 to control these aspects of the operation of power system 210, controller 53 may be operably connected to engine 10 and one or more components of drivetrain 212. Similarly, controller 53 may be operably connected to and configured to control the operating state of compression-braking device 214 and exhaust-braking device 216.

To provide controller 53 with operator input bearing on how to control power system 210, power-system controls 218 may include an operator interface 220 operably connected to controller 53, such as by a communication line. Operator interface 220 may include various components operable by the operator to communicate to controller 53 various aspects of how the operator desires machine 126 to operate. For example, operator interface 220 may include a direction selector 222 for communicating whether the operator desires propulsion of machine 126 and, if so, in what direction (i.e., forward or reverse). Similarly, operator interface 220 may include a speed selector 224 for use by the operator to communicate how fast the operator desires power system 210 to propel machine 126. Direction selector 222 and speed selector 224 may communicate a direction signal and a speed signal, respectively, to controller 53. Additionally, operator interface 220 may include an engine-braking input 226 for use by the operator to communicate a desire for engine braking to retard motion of machine 126. When activated by an operator, engine-braking input 226 may send an engine-braking signal to controller 53.

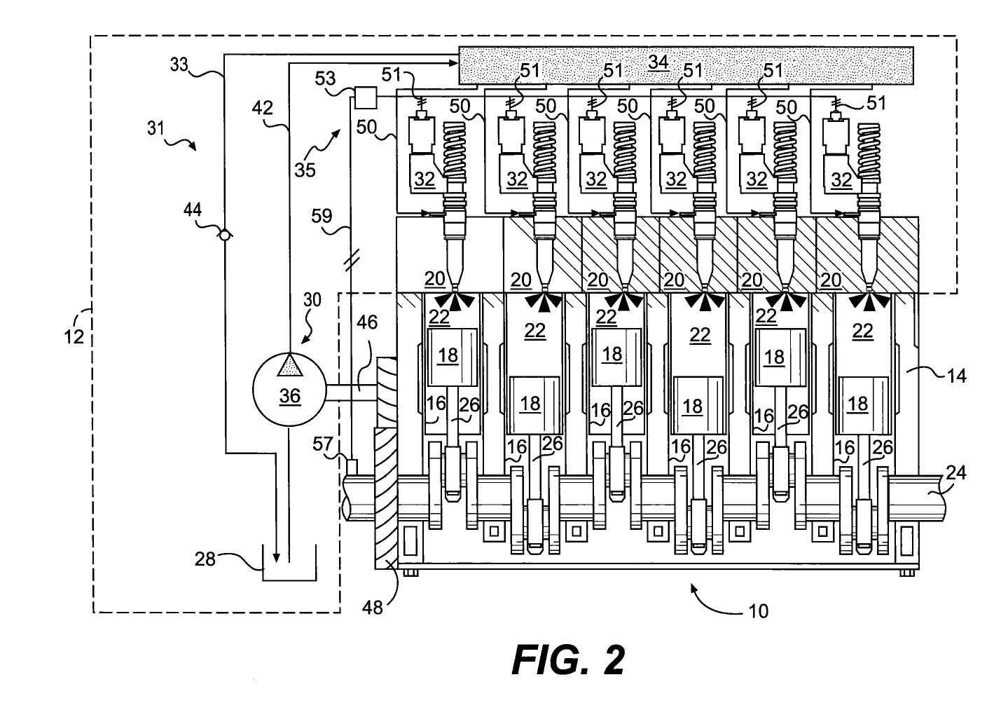

FIG. 2 illustrates one exemplary embodiment of engine 10 and a fuel system 12 thereof in greater detail. For the purposes of this disclosure, engine 10 is depicted and described as a four-stroke diesel engine. As noted above, however, engine 10 may be any other type of internal combustion engine such as, for example, a gasoline or a gaseous fuel-powered engine. Similarly, engine 10 may not be a four-stroke engine. Instead, engine 10 may be a two-stroke engine, or engine 10 may employ 6 or more strokes. Engine 10 may include one or more combustion chambers 22 and one or more drive members configured to be driven by the combustion of fuel in combustion chambers 22. In the example shown in FIG. 2, each drive member may be a piston 18. Engine 10 may include an engine block 14 that defines a plurality of cylinders 16 in each of which one of pistons 18 is slidably disposed. Engine 10 may further include a cylinder head 20 associated with each cylinder 16.

Each cylinder 16, piston 18, and cylinder head 20 may form one combustion chamber 22 of engine 10. In the illustrated embodiment, engine 10 includes six combustion chambers 22. However, it is contemplated that engine 10 may include a greater or lesser number of combustion chambers 22 and that combustion chambers 22 may be disposed in an “in-line” configuration, a “V” configuration, or any other suitable configuration.

As also shown in FIG. 1, engine 10 may include a crankshaft 24 that is rotatably disposed within engine block 14. A connecting rod 26 may connect each piston 18 to crankshaft 24, so that a sliding motion of piston 18 within each respective cylinder 16 results in a rotation of crankshaft 24. Similarly, a rotation of crankshaft 24 may result in a sliding motion of piston 18.

Fuel system 12 may include components that cooperate to deliver injections of pressurized fuel into each combustion chamber 22. Specifically, fuel system 12 may include a tank 28 configured to hold a supply of fuel, a fuel pumping arrangement 30 configured to pressurize the fuel and direct the pressurized fuel to a plurality of fuel injectors 32 by way of a manifold 34, a fuel return arrangement configured to return fuel from manifold 34, and a fuel-control system 35.

Fuel pumping arrangement 30 may include one or more pumping devices that function to increase the pressure of the fuel and direct one or more pressurized streams of fuel to manifold 34. In one example, fuel pumping arrangement 30 includes a low pressure source 36. Low pressure source 36 may embody a transfer pump configured to provide low pressure feed to manifold 34 via a fuel line 42. It is contemplated that fuel pumping arrangement 30 may include additional and/or different components than those listed above.

Fuel return arrangement 31 may include any component or components operable to return fuel from manifold 34 to tank 28. In some embodiments, fuel return arrangement 31 may include a return line 33 extending from manifold 34 to tank 28. Additionally, fuel return arrangement 31 may include a check valve 44 disposed within return line 33 to provide for one-directional flow of fuel from manifold 34 to tank 28. Check valve 44 may be a pressure regulator configured to regulate the amount of fuel pressure in manifold 34.

Low pressure source 36 may be operably connected to engine 10 and driven by crankshaft 24. Low pressure source 36 may be connected with crankshaft 24 in any manner readily apparent to one skilled in the art where a rotation of crankshaft 24 will result in a corresponding rotation of a pump drive shaft. For example, a pump driveshaft 46 of low pressure source 36 is shown in FIG. 1 as being connected to crankshaft 24 through a gear train 48. It is contemplated, however, that low pressure source 36 may alternatively be driven electrically, hydraulically, pneumatically, or in any other appropriate manner.

Fuel injectors 32 may be disposed within cylinder heads 20 and connected to manifold 34 by way of a plurality of fuel lines 50. Each fuel injector 32 may be operable to inject an amount of pressurized fuel into an associated combustion chamber 22 at predetermined timings, fuel pressures, and quantities. The timing of fuel injection into combustion chamber 22 may be synchronized with the motion of piston 18. For example, fuel may be injected as piston 18 nears a top-dead-center position in a compression stroke to allow for compression-ignited-combustion of the injected fuel. Alternatively, fuel may be injected as piston 18 begins the compression stroke heading towards a top-dead-center position for homogenous charge compression ignition operation. Fuel-control system 35 may control operation of fuel system 12 to provide specific injection events with a specific start of injection (SOI) timing, a specific start of injection pressure, a specific end of injection (EOI) pressure, and/or a specific quantity of injected fuel. Fuel-control system 35 may include controller 53 and various other control components.

Fuel-control system 35 may control operation of each fuel injector 32 in response to one or more inputs. As part of this, controller 53 may communicate with fuel injectors 32 by way of a plurality of communication lines 51 and with a sensor 57 by way of a communication line 59. Controller 53 may be configured to control a fuel injection timing, pressure, and amount by applying a determined current waveform or sequence of determined current waveforms to each fuel injector 32 based on input from sensor 57.

The timing of the applied current wave form or sequence of waveforms may be facilitated by monitoring an angular position of crankshaft 24 via sensor 57. In particular, sensor 57 may embody a magnetic pickup-type sensor configured to sense an angular position, velocity, and/or acceleration of crankshaft 24. From the sensed angular information of crankshaft 24 and known geometric relationships, controller 53 may be able to calculate the position of one or more components of fuel injector 32 that are operably driven by crankshaft 24 and thereby control the injection timing, pressure, and quantity as a function of the calculated position.

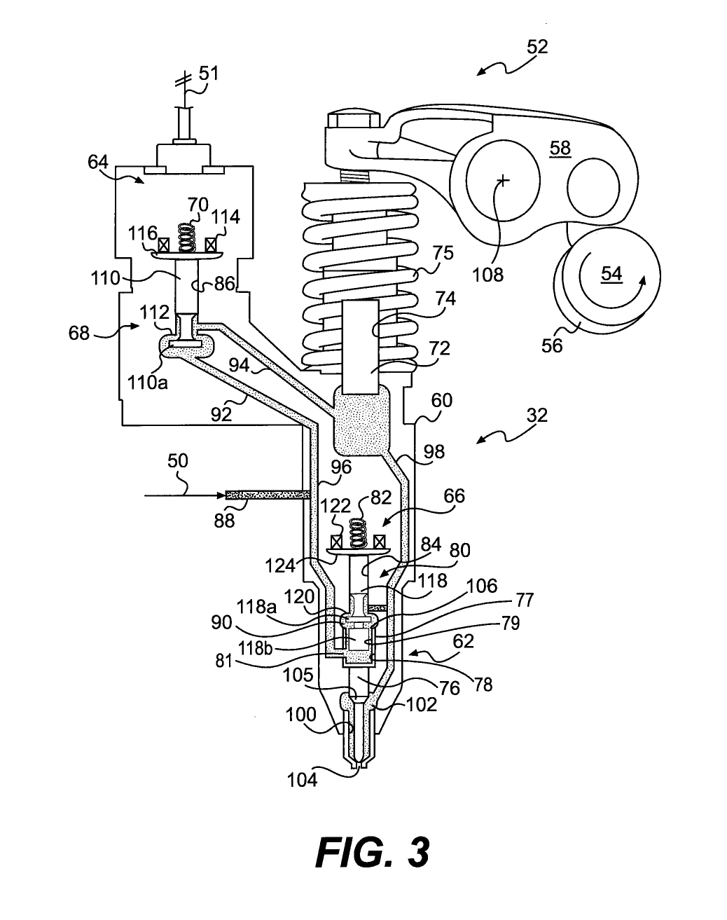

Fuel system 12 may have any of a variety of different configurations, including, but not limited to, a unit-type configuration and a common-rail configuration. In the case of a unit-type configuration, fuel injectors 32 may be mechanically or hydraulically actuated. FIG. 3 illustrates details of an exemplary configuration of one of fuel injectors 32 as a mechanically-operated pump-type unit fuel injector. In embodiments that use such a configuration for fuel injectors 32, each fuel injector 32 may, for example, be driven by a cam arrangement 52 to selectively pressurize fuel within fuel injector 32 to a desired pressure level. Cam arrangement 52 may include a cam 54 operably connected to crankshaft 24 such that a rotation of crankshaft 24 results in a corresponding rotation of cam 54. For example, cam arrangement 52 may be connected with crankshaft 24 through a gear train (not shown), through a chain and sprocket arrangement (not shown), or in any other suitable manner. As will be described in greater detail below, during rotation of cam 54, a lobe 56 of cam 54 may periodically drive a pumping action of fuel injector 32 via a pivoting rocker arm 58. It is contemplated that the pumping action of fuel injector 32 may alternatively be driven directly by lobe 56 without the use of rocker arm 58, or that a pushrod (not shown) may be disposed between rocker arm 58 and fuel injector 32.

Fuel injector 32 may include multiple components that interact to pressurize and inject fuel into combustion chamber 22 of engine 10 in response to the driving motion of cam arrangement 52. In particular, each fuel injector 32 may include an injector body 60 having a nozzle portion 62, a plunger 72 disposed within a bore 74 of injector body 60, a plunger spring 75, a valve needle 76, a valve needle spring (not shown), a spill valve 68, a spill valve spring 70, a first electrical actuator 64, a direct operated check (DOC) valve 80, a DOC spring 82, and a second electrical actuator 66. It is contemplated that additional or different components may be included within fuel injector 32 such as, for example, restricted orifices, pressure-balancing passageways, accumulators, and other injector components known in the art.

Injector body 60 may embody a generally cylindrical member configured for assembly within cylinder head 20 and having one or more passageways. Specifically, injector body 60 may include bore 74 configured to receive plunger 72, a bore 84 configured to receive DOC valve 80, a bore 86 configured to receive spill valve 68, and a control chamber 90. Injector body 60 may also include a fuel supply/return line 88 in communication with bores 86, 74, 84, control chamber 90, and nozzle portion 62 via fluid passageways 92, 94, 96, and 98, respectively. Below control chamber 90, fuel injector 32 may include a piston 77 disposed in a bore 78 of injector body 60. Piston 77 may have a central bore 79 and a hydraulic surface 106 extending around central bore 79 at a top end of piston 77. A lower end of piston 77 may abut an upper end of valve needle 76. Control chamber 90 may be selectively drained of or supplied with pressurized fuel to affect motion of valve needle 76 via piston 77. It is contemplated that injector body 60 may alternatively embody a multi-member element having one or more housing members, one or more guide members, and any other suitable number and/or type of structural members.

Nozzle portion 62 may likewise embody a cylindrical member having a central bore 100 and a pressure chamber 102. Central bore 100 may be configured to receive valve needle 76. Pressure chamber 102 may hold pressurized fuel supplied from fluid passageway 98 in anticipation of an injection event. Nozzle portion 62 may also include one or more orifices 104 to allow the pressurized fuel to flow from pressure chamber 102 through central bore 100 into combustion chambers 22 of engine 10.

Plunger 72 may be slidingly disposed within bore 74 and movable by rocker arm 58 to pressurize fuel within bore 74. Specifically, as lobe 56 pivots rocker arm 58 about a pivot point 108, an end of rocker arm 58 opposite lobe 56 may urge plunger 72 against the bias of plunger spring 75 into bore 74, thereby displacing and pressurizing the fuel within bore 74. The fuel pressurized by plunger 72 may be selectively directed through fluid passageways 92-98 to spill valve 68, DOC valve 80, control chamber 90, supply/return line 88, and pressure chamber 102 associated with piston 77 and valve needle 76. As lobe 56 rotates away from rocker arm 58, fuel pressure acting on a lower end of plunger 72 may drive plunger 72 upward, allowing fuel to flow upward as plunger 72 retracts.

Valve needle 76 may be an elongated cylindrical member that is slidingly disposed within central bore 100 of nozzle portion 62. Valve needle 76 may be axially movable between a first position at which a tip end of valve needle 76 blocks a flow of fuel through orifice 104, and a second position at which orifice 104 is open to allow a flow of fuel into combustion chamber 22. It is contemplated that valve needle 76 may be a multi-member element having a needle member and a piston member, or a single integral element.

Valve needle 76 may have multiple driving surfaces. For example, valve needle 76 may include a hydraulic surface 105 that opposes the bias of the valve needle spring to drive valve needle 76 in the opposite direction toward a second or orifice-opening position when acted upon by pressurized fuel. Valve needle 76 may also include a driving surface 107 that engages a lower end of piston 77, such that the pressure of fuel in control chamber 90 on hydraulic surface 106 of piston 77 tends to drive valve needle 76 with the bias of the valve needle spring toward an orifice-blocking position. When both hydraulic surfaces 105 and 106 are exposed to substantially the same fluid pressures, the forces exerted on valve needle 76 may be sufficient to move valve needle 76 to and hold valve needle 76 in the orifice-blocking position. These forces holding valve needle 76 in the orifice-blocking position may include the force of the valve needle spring biasing valve needle 76 to the orifice-blocking position. Additionally, when the pressures on hydraulic surfaces 105 and 106 are approximately the same, a net hydraulic force driving valve needle 76 toward the orifice blocking position may result. This net hydraulic force may stem from the fact that the portion of valve needle 76 within orifice 104 is not exposed to the pressure of fuel in pressure chamber 102. Because of this, the fuel pressing valve needle 76 to the orifice-blocking position acts on a greater surface area than the fuel pressing valve needle 76 in the opposite direction.

Spill valve 68 may be disposed between fluid passageways 92 and 94 and configured to selectively allow fuel displaced from bore 74 to flow through fluid passageway 92 to supply/return line 88 where the pressurized fuel may exit fuel injector 32. Specifically, spill valve 68 may include a valve element 110 connected to first electrical actuator 64. Valve element 110 may have a region of enlarged diameter 110a, which is engageable with a valve seat 112 to selectively block the flow of pressurized fuel from fluid passageway 94 to fluid passageway 92. Movement of region 110a away from valve seat 112 may allow the pressurized fuel to flow from fluid passageway 94 to fluid passageway 92 and exit fuel injector 32 via supply/return line 88. When fuel forced from bore 74 is allowed to exit fuel injector 32 via supply/return line 88, the buildup of pressure within fuel injector 32 due to inward displacement of plunger 72 may be minimal. However, when the fuel is blocked from supply/return line 88, the displacement of fuel from bore 74 may result in an increase of pressure within fuel injector 32. Spill valve spring 70 may be situated to bias spill valve 68 toward the flow passing position.

First electrical actuator 64 may include a solenoid 114 and armature 116 for controlling motion of spill valve 68. In particular, solenoid 114 may include windings of a suitable shape through which current may flow to establish a magnetic field such that, when energized, armature 116 may be drawn toward solenoid 114. Armature 116 may be fixedly connected to valve element 110 to move region 110a of valve element 110 against the bias of spill valve spring 70 and into engagement with valve seat 112.

DOC valve 80 may be disposed between fluid passageway 98 and control chamber 90, and configured to selectively block fuel displaced from bore 74 from flowing to control chamber 90, thereby facilitating fuel injection through orifice 104. Specifically, DOC valve 80 may include a valve element 118 connected to second electrical actuator 66. Valve element 118 may have a region of enlarged diameter 118a, which is engageable with a valve seat 120 to selectively block the flow of pressurized fuel from control chamber 90. When the pressurized fuel from fluid passageway 98 is blocked from control chamber 90, an imbalance of force on valve needle 76 may be generated that causes valve needle 76 to move against the spring bias toward the flow-passing position. Disengagement of region 118a from valve seat 120 may allow the pressurized fuel to flow from fluid passageway 98 into control chamber 90, the influx of pressurized fluid thereby returning valve needle 76 to the injection-blocking position. DOC spring 82 may be situated to bias DOC valve 80 toward the flow passing position. DOC valve 80 may also include a cylindrical portion 118b disposed within central bore 79 of piston 77. A small radial clearance between cylindrical portion 118b and central bore 79 of piston 77 may always allow a small leakage flow from control chamber 90 to passage 96 via a side opening 81 in piston 77.

Second electrical actuator 66 may include a solenoid 122 and armature 124 for controlling motion of DOC valve 80. In particular, solenoid 122 may include windings of a suitable shape through which current may flow to establish a magnetic field such that, when energized, armature 124 may be drawn toward solenoid 122. Armature 124 may be fixedly connected to valve element 118 to move region 118a of valve element 118 against the bias of DOC spring 82 and into engagement with valve seat 120.

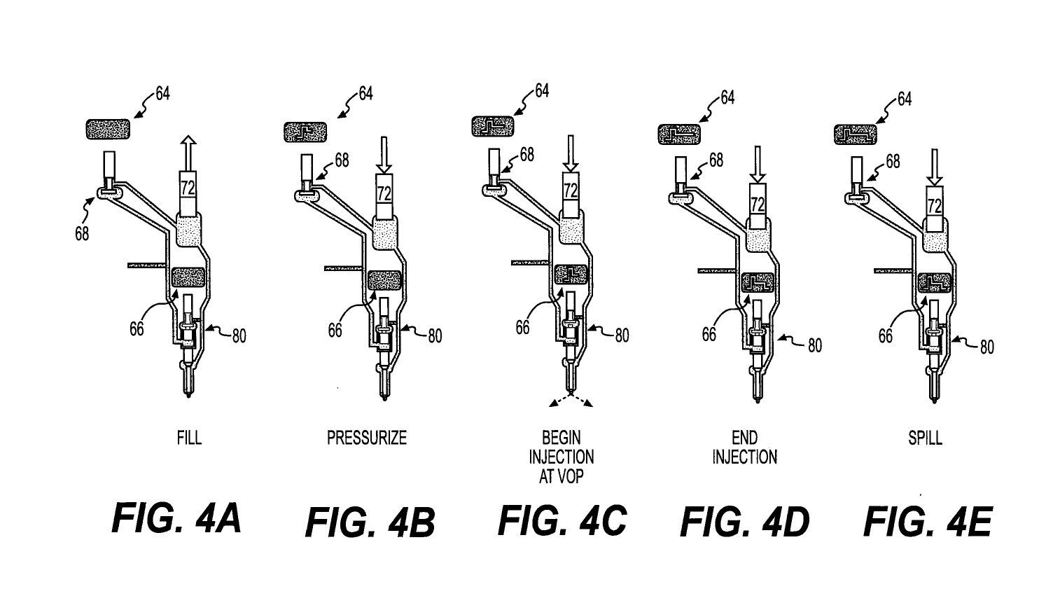

FIGS. 4A-4E illustrate how a fuel injector 32 of the configuration shown in FIG. 3 may be operated to inject fuel into one of combustion chambers 22. Starting from the position illustrated in FIG. 4A, fuel injector 32 may fill with fuel when both of first and second electronic actuators 64, 66 are de-energized. In particular, as lobe 56 rotates away from rocker arm 58, plunger spring 75 may urge plunger 72 upward out of bore 74. The outward motion of plunger 72 from bore 74 may act to draw fuel from supply/return line 88 into bore 74 via fluid passageway 92, de-energized spill valve 68, and fluid passageway 94. During the filling operation of fuel injector 32, the forces caused by fluid pressures acting on valve needle 76 may be slightly imbalance in the direction of holding valve needle 76 in the orifice blocking position, and the valve needle spring may assist these fluid pressures in holding valve needle 76 in the orifice blocking position.

To pressurize the fuel within fuel injector 32, lobe 56 may rotate into engagement with rocker arm 58 to drive plunger 72 into bore 74, thereby displacing fuel from bore 74. If valve element 110 of spill valve 68 remains in the de-energized flow-passing position of FIG. 4A, the fuel displaced by plunger 72 may flow back through fluid passageways 94 and 92 to exit fuel injector 32 via supply/return line 88 without a substantial increase in pressure. However, if valve element 110 of spill valve is moved to the energized flow-blocking position during inward movement of plunger 72, as illustrated in FIG. 4B, the fuel displaced from bore 74 may be blocked from exiting fuel injector 32, thereby causing the pressure within fuel injector 32 to increase in proportion to the displacement of plunger 72. In order to prevent injection during pressurizing of the fuel within fuel injector 32, valve element 118 of DOC valve 80 may remain in the de-energized flow passing position to allow the buildup of pressure acting on hydraulic surface 106 to counteract the buildup of pressure acting on hydraulic surface 105, thereby allowing the valve needle spring to retain valve needle 76 in the orifice-blocking position.

When injection is desired, second electrical actuator 66 may be energized to draw valve element 118 of DOC valve 80 into engagement with valve seat 120, as illustrated in FIG. 4C. In this energized state, the fuel pressurized by the inward movement of plunger 72 may be blocked from hydraulic surface 106, but allowed to remain in contact with hydraulic surface 105. After valve element 118 moves to the flow-blocking position, the pressure of the fuel within control chamber 90 may be lower than the pressure of the fuel acting against hydraulic surface 105. As used herein, the “flow-blocking position” of DOC valve 80 refers to the position in which the region of enlarged diameter 118a of the valve element 118 engages the seat 120 and blocks flow of high-pressure fuel from passage 98 into control chamber 90. It will be understood that in both this “flow-blocking position” and the “flow-passing position” of DOC valve 80, cylindrical portion 118b of valve element 118 may allow some leakage of fuel from control chamber 90 to passage 96 via the small radial clearance between cylindrical portion 118b and central bore 79 of piston 77 and side opening 81 of piston 77. When DOC valve 80 is in the flow-blocking position and preventing flow of high-pressure fuel into control chamber 90, the imbalance of force created by the pressure differential on the hydraulic surfaces of valve needle 76 and piston 77 may act to move valve needle 76 against the bias of the valve needle spring, thereby opening orifice 104 and initiating injection of the pressurized fuel into combustion chamber 22. The time at which valve needle 76 moves away from orifice 104 may correspond to the start of injection timing of fuel injector 32. The displacement of plunger 72 that occurs after valve element 110 has moved to the flow-blocking position and before valve element 118 of DOC valve 80 has moved to the flow-blocking position may correspond to the pressure of the fuel at the start of injection.

To end injection, second electrical actuator 66 may be de-energized to allow valve element 118 of DOC valve 80 to return to the flow-passing position under the bias of DOC spring 82, as illustrated in FIG. 3D. As valve element 118 moves to the de-energized flow-passing position, high pressure fuel may be reintroduced into control chamber 90, thereby allowing the valve needle spring to urge valve needle 76 to the orifice-blocking position. As valve needle 76 reaches the orifice-blocking position, the injection of fuel into combustion chamber 22 may terminate. The displacement of plunger 72 that occurs after valve needle 76 has moved to the flow-passing position and before valve needle 76 returns to the flow-blocking position may correspond to the amount of fuel injected into combustion chamber 22. The time at which valve needle 76 returns to the orifice-blocking position may correspond to the EOI timing of fuel injector 32. The EOI pressure may be a function of plunger velocity and the opening area of orifice 104.

As illustrated in FIG. 4E, almost immediately following the movement of valve element 118 to the flow-passing position, valve element 110 may likewise be moved to the flow-passing position to relieve the pressure of the fuel within fuel injector 32 and reduce the load on cam arrangement 52. It is contemplated that if a particular end of injection pressure is desired, valve element 110 may be moved to the flow passing position at a predetermined plunger displacement distance before valve element 118 is moved to the flow passing position to vary (i.e., reduce) the pressure of the fuel discharged through orifice 104.

A time lag may be associated with each of spill valve 68, DOC valve 80, and valve needle 76 between the time that current is applied to or removed from the windings of solenoids 114 and 122, and the time that the respective valve elements actually begin to move or reach their fully closed or open positions. Controller 53 may be configured to determine and apply a delay offset that accounts for this delay when closing or opening spill valve 68 and DOC valve 80.

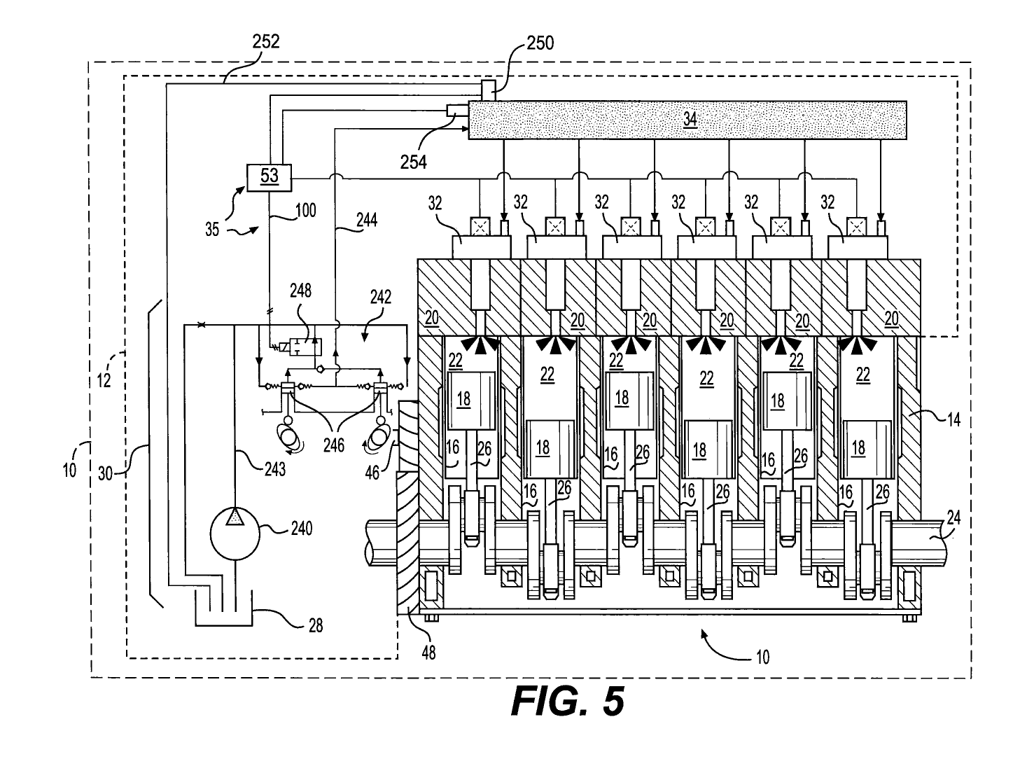

As noted above, instead of a unit-type configuration like that shown in FIGS. 2, 3, and 4A-4E, fuel system 12 may have various other configurations. For example, FIG. 5 illustrates an example where engine 10 has a fuel system 12 with a common-rail configuration. Aside from fuel system 12, the embodiment of engine 10 shown in FIG. 5 is substantially the same as the embodiment of engine 10 shown in FIG. 2.

Additionally, the embodiment of fuel system 12 shown in FIG. 5 shares many characteristics with the embodiment of fuel system shown in FIG. 2. Like the embodiment of fuel system 12 shown in FIG. 2, the embodiment of fuel system 12 shown in FIG. 5 includes a tank 28 configured to hold a supply of fuel, a fuel pumping arrangement 30 configured to pressurize the fuel and direct the pressurized fuel to a plurality of fuel injectors 32 by way of a manifold 34, and a fuel-control system 35.

On the other hand, in the embodiment shown in FIG. 5, the configuration and operation of fuel pumping arrangement 30 and fuel injectors 32 may differ from the embodiment shown in FIG. 2. Fuel pumping arrangement 30 may include a low-pressure source 240 and a high-pressure source 242. Low-pressure source 240 may embody a transfer pump that provides low-pressure feed to high-pressure source 242 via a passageway 243. High-pressure source 242 may embody a pump that receives the low-pressure feed from low-pressure source 240 and increases the pressure of the fuel. High-pressure source 242 may be connected to manifold 34 by way of a fuel line 244, such that the high pressure fuel discharged by high-pressure source 242 is fed to manifold 34.

One or both of low and high-pressure sources 240, 242 may be operatively connected to engine 10 and driven by crankshaft 24. Low and/or high-pressure sources 240, 242 may be connected with crankshaft 24 in any manner readily apparent to one skilled in the art where a rotation of crankshaft 24 will result in a corresponding driving rotation of a pump shaft. For example, a pump driveshaft 46 of high-pressure source 242 is shown in FIG. 5 as being connected to crankshaft 24 through gear train 48.

In some embodiments, high-pressure source 242 may be configured to discharge a controllably variable amount of fuel per pumping cycle. For example, high-pressure source 242 may include cam-driven plungers 246 that reciprocate to displace fuel and a spill valve 248 that controls how much of the displaced fuel recirculates within high-pressure source 242 and how much gets pumped out of high-pressure source 242. Additionally, controller 53 may be operably connected to spill valve 248 of high-pressure source 242, such that controller 53 may control the amount of fuel pumped to manifold 34 by high-pressure source 242.

As noted above, the configuration of fuel injectors 32 used in the embodiment of FIG. 5 may also differ from the configuration of fuel injectors 32 shown in FIGS. 2, 3, and 4A-4E. In the embodiment shown in FIG. 5, fuel injectors 32 may not include provisions for further pressurizing fuel inside the fuel injectors 32. Instead, each of fuel injectors 32 may discharge fuel by opening one or more internal valves (not shown) and relying on pressure in manifold 34 to drive the fuel from a nozzle of the fuel injector 32. To control their one or more internal valves, each of fuel injectors 32 may, for example, use one or more electric solenoids (not shown). These electric solenoids may be operatively connected to controller 53 to allow controller 53 to control when and for how long each of fuel injectors 32 discharges fuel.

The embodiment of fuel system 12 shown in FIG. 5 may also differ from the embodiment of FIG. 2 by the addition of a controllable pressure-relief valve 250 in fluid communication with manifold 34. Pressure-relief valve 250 may be configured to selectively allow fluid communication between manifold 34 and a return line 252 that goes to tank 28. When pressure-relief valve 250 opens, it may allow fuel to escape manifold 34 and flow through return line 252 to tank 28. Pressure-relief valve 250 may include various provisions for controlling when it opens. In some embodiments, pressure-relief valve 250 may include a spring-loaded mechanism (not shown) that opens pressure-relief valve 250 at a predetermined pressure to avoid over pressurization of manifold 34. Additionally or alternatively, pressure-relief valve 250 may include one or more controllable actuators, such as one or more electric solenoids, operable to open pressure-relief valve 250 when actuated. Controller 53 may be operatively connected to the one or more controllable actuators of pressure-relief valve 250, so that controller 53 may trigger opening and closing of pressure-relief valve 250 to release fuel and pressure from manifold 34.

In the embodiment shown in FIG. 5, fuel system 12 may also include provisions for monitoring the pressure in manifold 34. For example, fuel system 12 may include a pressure sensor 254 in fluid communication with manifold 34. Controller 53 may be operatively connected to pressure sensor 254, so that controller 53 may monitor the pressure of manifold 34 via a signal received from pressure sensor 254.

Machine 126, power system 210, engine 10, and fuel system 12 are not limited to the examples illustrated in FIGS. 1-3, 4A-4E, and 5. For example, machine 10 and power system 210 may be configured to use the power of engine 10 in ways other than for propulsion. Additionally, power system 210 may omit one or both of compression-braking device 214 and exhaust-braking device 216, and/or power-system 210 may include one or more other types of engine-braking devices. Power system 210 may also include different configurations of power-system controls 218. For example, in addition to or instead of controller 53, power-system controls 218 may include various other components, such as other controllers, that control one or more aspects of the operation of power system 210. Additionally, in some embodiments, power-system controls 218 may have provisions for controlling machine 126 partially or fully autonomously. In some such embodiments, operator interface 220 may omit one or more of the components shown in the drawings, and/or operator interface 220 may be omitted entirely. Furthermore, fuel system 12 may have configurations other than the examples of the unit-type configuration shown in FIGS. 2, 3, and 4A-4E and the common-rail configuration shown in FIG. 5.

### INDUSTRIAL APPLICABILITY

Machine 126 and power system 210 may have use in any application requiring power to perform one or more tasks. For example, where power system 210 is configured to propel machine 126, machine 126 and power system 210 may have use for moving various things, include cargo and/or passengers. When an operator requests propulsion via operator interface 220 or power-system controls 218 autonomously determine to propel machine 126, power-system controls 218 may operate engine 10 to generate power and operate drivetrain 212 to transmit that power to propulsion devices 130.

When operating engine 10 to produce power, power-system controls 218 may operate fuel system 12 to inject fuel into combustion chambers 22. The fuel injected into combustion chambers 22 may combust, driving pistons 18, connecting rods 26, and crankshaft 24. As discussed in more detail above in connection with FIGS. 4A-4E, injecting fuel into a combustion chamber 22 with the first embodiment of fuel system 12 may involve closing spill valve 68 while plunger 72 is descending to pressurize fuel in fuel injector 32, followed by closing DOC valve 80 to trigger injection of fuel from the one or more orifices of fuel injector 32. In the case of the embodiment of fuel system 12 shown in FIG. 5, injecting fuel into a combustion chamber 22 may involve activating one or more controllable actuators of fuel injector 32 to open one or more valves in fuel injector 32 and allow pressure in manifold 34 to force fuel from fuel injector 32 into the combustion chamber 22. By operating fuel system 12 in these manners, controller 53 may selectively control engine 10 to produce power.

In other circumstances, controller 53 may control fuel system 12 to refrain from delivering fuel to combustion chambers 22 while the internal components, including pistons 18, of engine 10 are moving. For example, when machine 126 is travelling with the internal components of engine 10 moving and an operator activates engine-braking input 226 to indicate a desire for engine braking, controller 53 may control fuel system 12 to abstain from delivering fuel to combustion chambers 22. While abstaining from delivering fuel to combustion chambers 22 in response to receiving an engine-braking signal from engine-braking input 226, controller 53 may also control fuel system 12 to generate parasitic losses on engine 10 with fuel system 12.

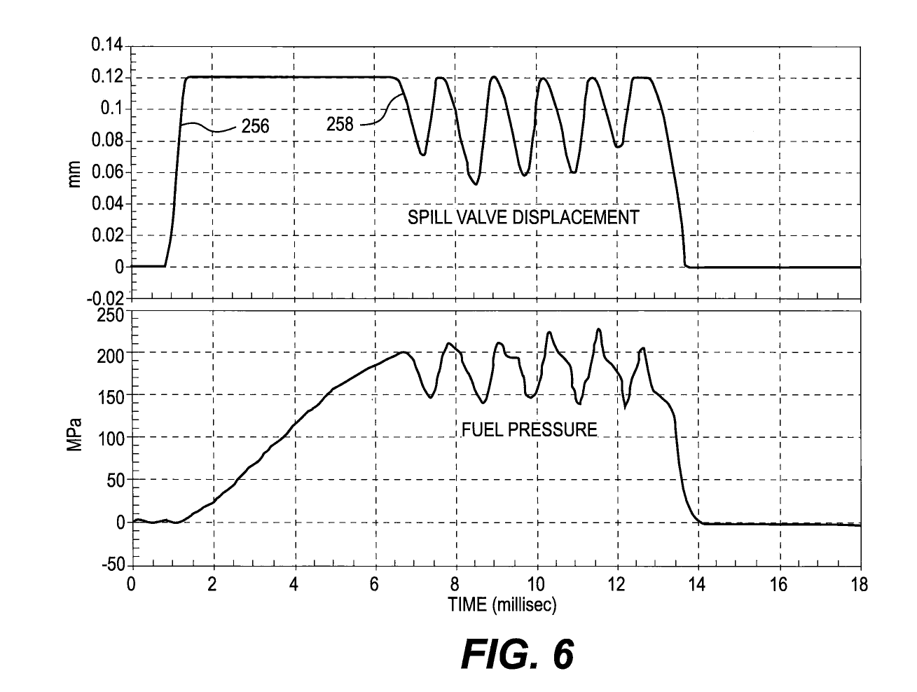

One way in which controller 53 may control fuel system 12 to generate parasitic losses while abstaining from delivering fuel to combustion chambers 22 will now be discussed in connection with FIG. 6. FIG. 6 graphically illustrates how controller 53 may control certain parameters of the embodiment of fuel system shown in FIGS. 2, 3, and 4A-4E to provide parasitic losses with fuel system 12 while abstaining from injecting fuel into combustion chambers 22. The timeframe of the charts in FIG. 6 may correspond to one full operating cycle of engine 10. In the case where engine 10 is a four-stroke diesel engine, a full operating cycle of engine 10 may be two full revolutions of crankshaft 24. The upper chart in FIG. 6 illustrates the position of spill valve 68 of one of fuel injectors 32 during a time period when the plunger 72 of the fuel injector is descending. The lower chart in FIG. 6 illustrates the fuel pressure inside fuel injector 32 as a result of the operation of the spill valve 68 graphically illustrated in the upper chart. As shown in the upper chart, near the beginning of the illustrated time period, controller 53 may close spill valve 68 during a spill valve closing event 256, after which controller 53 may hold spill valve 68 closed for a period of time.

As shown in the lower chart of FIG. 6, after spill valve closing event 256, the pressure in fuel injector 32 may rise while plunger 72 descends. Then, controller 53 may open spill valve 68 part way at a spill valve opening event 258, which may allow fuel to escape from fuel injector 32 to return line 88 via spill valve 68. As a result, the pressure in fuel injector 32 may decrease. As shown in the upper chart, controller 53 may subsequently cycle spill valve 68 open and closed a number of times, building and releasing pressure in fuel injector 32. Thus, controller 53 may operate fuel system 12 to generate and dissipate pressure in fuel injector 32 multiple times during one operating cycle of engine 10. During all of this time, controller 53 may control DOC valve 80 to remain in the flow-passing position to maintain needle valve 76 in the orifice-blocking position, thereby preventing injection of fuel for combustion.

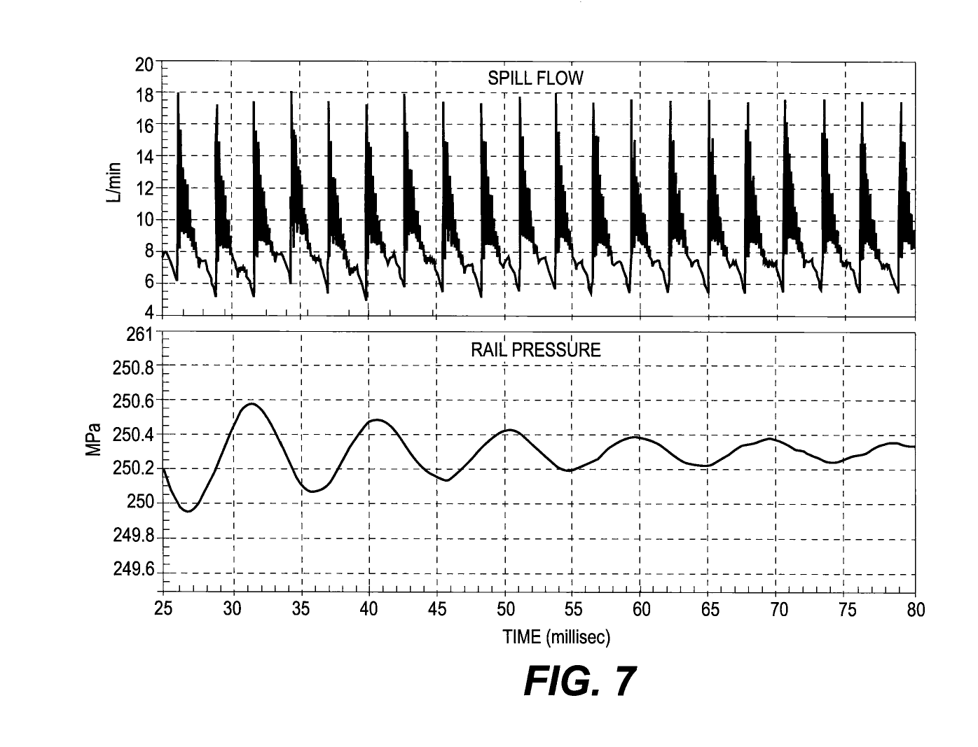

FIG. 7 provides charts that illustrate how controller 53 may control certain operating parameters of the embodiment of fuel system 12 shown in FIG. 5 to produce parasitic losses with fuel system 12. The timeframes of the charts in FIG. 7 may correspond to one full operating cycle of engine 10. During the time period illustrated in the charts of FIG. 7, high-pressure source 242 may be supplying fuel at high pressure to manifold 34. The upper chart in FIG. 7 illustrates how controller 53 may control release of fuel from manifold 34 back to tank 28 via pressure-relief valve 250 and return line 242. The lower chart in FIG. 7 illustrates how the pressure in manifold 34 may vary over the time period shown in the upper chart. As reflected in the upper chart of FIG. 7, while high-pressure source 242 is supplying fuel to manifold 34, controller 53 may vary the amount by which pressure-relief valve 250 is open to cause cyclical fluctuations in the amount of fuel allowed to flow from manifold 34 back to tank 28. As shown in the lower chart of FIG. 7, with the high-pressure source 242 supplying fuel to manifold 34 and pressure-relief valve 250 allowing a variable amount of fuel out of manifold 34, the pressure in manifold 34 may fluctuate. Thus, controller 53 may operate fuel system 12 to generate and dissipate pressure in common-rail manifold 34 multiple times during one operating cycle of engine 10.

By building and releasing pressure in fuel system 12 in the manners shown in FIGS. 6 and 7, fuel system 12 creates a parasitic load on engine 10. This occurs because the energy to build pressure is derived from engine 10. For example, in the case of the embodiment discussed in connection with FIGS. 2, 3, 4A-4E and 6, the energy to build pressure in each fuel injector 32 comes from the cam arrangement 52 of engine 10 driving plunger 72 of fuel injector 32. In the case of the embodiment discussed in connection with FIGS. 5 and 7, the energy to build pressure in manifold 34 comes from high-pressure source 242 pumping fuel into manifold 34, and high-pressure source 242 derives its power from engine 10 via gear train 48 and crankshaft 24. When the pressure generated in fuel injector 32 and/or manifold 34 is released, this energy is dissipated, rather than returned to engine 10. Thus, the process of building and releasing pressure in fuel system 12 creates a net power loss on engine 10.

While controlling fuel system 12 to generate parasitic losses in response to an engine-braking signal, controller 53 may abstain from triggering a release of fuel from a fuel injector 32 into a combustion chamber 22. Indeed, controller 53 may abstain from delivering fuel from the fuel injector 32 for an entire operating cycle of engine 10, or multiple operating cycles of engine 10. For example, where engine 10 is a four-stroke engine and each two revolutions of crankshaft 24 may constitute a full operating cycle of engine 10, controller 53 may refrain from discharging fuel from a fuel injector 32 for two or more revolutions of crankshaft 24 while creating parasitic losses with fuel system 12. Similarly, in embodiments where engine 10 is a two-stroke engine and each revolution of crankshaft 24 corresponds to a complete operating cycle of engine 10, controller 53 may refrain from discharging fuel from a fuel injector 32 for one or more full revolutions of crankshaft 24.

When fuel system 12 is not operating to discharge fuel into combustion chambers 22 to produce power with engine 10, there may be fewer constraints on how controller 53 can control the pressure in fuel system 12 to generate parasitic losses. Accordingly, when controlling fuel system to create parasitic losses by generating and releasing pressure in fuel injector 32 and/or manifold 34, controller 53 may drive the pressure in these components to higher levels than during times when controlling fuel system 12 to discharge fuel into combustion chambers 22 to produce power with engine 10. This may help enhance the load that fuel system 12 may place on engine 10.

While operating fuel system 12 to generate parasitic load on engine 10, controller 53 may also operate one or more of the dedicated engine-braking devices, such as compression-braking device 214 and/or exhaust-braking device 216, in response to an engine-braking signal from engine-braking input 226. This may increase the total parasitic loss experienced by engine 10. The parasitic losses of engine 10 generated during such operation may be employed for a number of advantageous purposes. For example, where machine 126 is in motion and drivetrain 212 is in such an operating state that crankshaft 24 of engine 10 is drivingly connected to propulsion devices 130, the parasitic loads placed on engine 10 by fuel system 12, compression-braking device 214, and exhaust-braking device 216 may draw power from propulsion devices 130. This may tend to brake machine 126.

Operation of power system 210, engine 10, and fuel system 12 is not limited to the examples discussed above. For instance, controller 53 may control the generation and release of pressure in fuel system 12 in different manners than shown in FIGS. 6 and 7 to generate parasitic losses. Furthermore, in addition to operating fuel system 12 to generate parasitic losses when refraining from injecting fuel in response to an engine-braking signal, controller 53 may operate fuel system 12 to generate parasitic losses during other times. Additionally, controller 53 may operate fuel system 12 to generate parasitic losses without operating compression-braking device 214 and exhaust-braking device 216 to generate parasitic losses.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. A method of operating a power system having an engine, the engine having a combustion chamber, a drive member, and a fuel system with a fuel injector, the method comprising:
selectively operating the fuel system to supply fuel from the fuel injector to the combustion chamber and combusting the fuel in the combustion chamber to drive the drive member; and
selectively operating the fuel system to generate parasitic losses without supplying fuel to the combustion chamber to drive the drive member, including
generating pressure in a component of the fuel system with power derived from the engine, and
dissipating at least a portion of the generated pressure without delivering fuel from the fuel injector to the combustion chamber.

2. The method of claim 1, wherein selectively operating the fuel system to generate parasitic losses without supplying fuel to the combustion chamber includes generating and dissipating pressure in the component a plurality of times during one operating cycle of the engine.

3. The method of claim 1, wherein:
selectively operating the fuel system to supply fuel from the fuel injector to the combustion chamber and combusting the fuel in the combustion chamber to drive the drive member also includes generating pressure in the component of the fuel system; and
generating pressure in the component of the fuel system when operating the fuel system to generate parasitic losses without supplying fuel to the combustion chamber includes generating higher pressure in the component than when operating the fuel system to supply fuel from the fuel injector to the combustion chamber.

4. The method of claim 1, wherein:
the fuel injector is a unit-type injector with a plunger, a spill valve, and a DOC valve; and
generating pressure in a component of the fuel system with power derived from the engine includes driving the plunger of the injector while holding the spill valve closed and the DOC valve open.

5. The method of claim 4, wherein dissipating at least a portion of the generated pressure includes opening the spill valve.

6. The method of claim 1, wherein:
the fuel system includes a common-rail manifold connected to the fuel injector;
the fuel system includes a pump connected to the common rail manifold; and
generating pressure in a component of the fuel system with power derived from the engine includes generating pressure in the common-rail manifold with the pump.

7. The method of claim 6, wherein dissipating at least a portion of the generated pressure includes operating a controllable valve to release pressure from the common-rail manifold.

8. The method of claim 1, wherein selectively operating the fuel system to generate parasitic losses without supplying fuel to the combustion chamber includes doing so in response to a braking signal.

9. The method of claim 8, wherein:
the power system further includes one or more-engine braking devices; and
the method further comprises operating one or more of the engine-braking devices in response to the braking signal to generate parasitic loads on the engine.

10. The method of claim 8, wherein:
the power system further includes a compression-braking device for the engine; and
the method further comprises operating the compression-braking device in response to the braking signal to generate parasitic loads on the engine.

11. The method of claim 8, wherein:
the power system further includes an exhaust-braking device for the engine; and
the method further comprises operating the exhaust-braking device in response to the braking signal to generate parasitic loads on the engine.

12. A power system, comprising:
an engine, the engine including
a combustion chamber;
a drive member;
a fuel system with a fuel injector; and
a controller, the controller being configured to
selectively operate the fuel system to supply fuel from the fuel injector to the combustion chamber to combust the fuel in the combustion chamber and drive the drive member; and
selectively operate the fuel system to generate parasitic losses without supplying fuel to the combustion chamber to drive the drive member, including
generating pressure in a component of the fuel system with power derived from the engine, and
dissipating at least a portion of the generated pressure without delivering fuel from the fuel injector to the combustion chamber.

13. The power system of claim 12, wherein:
the fuel injector is a unit-type injector with a plunger, a spill valve, and a DOC valve;
generating pressure in a component of the fuel system with power derived from the engine includes driving the plunger of the injector while holding the spill valve closed and the DOC valve open.

14. The power system of claim 13, wherein dissipating at least a portion of the generated pressure includes opening the spill valve.

15. The power system of claim 12, wherein:
the fuel system includes a common-rail manifold connected to the fuel injector;
the fuel system includes a pump connected to the common rail manifold; and
generating pressure in a component of the fuel system with power derived from the engine includes generating pressure in the common-rail manifold with the pump.

16. The power system of claim 15, wherein dissipating at least a portion of the generated pressure includes operating a controllable valve to release pressure from the common-rail manifold.

17. The power system of claim 12, wherein the controller is configured to execute the process of operating the fuel system to generate parasitic losses without supplying fuel to the combustion chamber in response to a braking signal.

18. A method of operating a power system with an engine having a fuel system, the method comprising:
generating a braking signal; and
in response to the braking signal, altering operation of the fuel system to increase parasitic losses of the fuel system.

19. The method of claim 18, wherein altering operation of the fuel system to increase parasitic losses of the fuel system includes:
generating pressure in a component of the fuel system with power derived from the engine; and
dissipating at least a portion of the generated pressure without delivering fuel from the fuel injector to the combustion chamber.

20. The method of claim 18, wherein:
the power system further includes one or more-engine braking devices; and
the method further comprises operating one or more of the engine-braking devices in response to the braking signal to generate parasitic loads on the engine.
